(19) United States
(12) Patent Application Publication
(10) Pub. No.: US 2007/0049360 A1
(43) Pub. Date: Mar. 1, 2007

(54) Cell phone interface to personal protection device

(76) Inventors: Joseph Birli, Munson, OH (US); Dave Potts, Parma Hts., OH (US); Frank Torrieri, Perry, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/212,076

(22) Filed: Aug. 25, 2005

(51) Int. Cl. H04Q 7/32

(52) U.S. Cl. 455/575.2; 455/575.1

(57) ABSTRACT

In one aspect the invention relates to apparatus comprising a personal protection device, a microphone and speaker on the device, a cell phone, and a cable for electrically connecting the microphone and the speaker with the cell phone. In another aspect the invention relates to apparatus comprising a personal protection device, a microphone and speaker on the device, and a cable for electrically connecting the microphone and the speaker with the cell phone. In still another aspect, the invention relates to a cable for electrically connecting the microphone and the speaker that are on a personal protection device, with a cell phone.

### BACKGROUND OF THE INVENTION

This invention relates to enabling communication via cell phone when a user is wearing a personal protection device (“PPD”), such as a mask, a helmet, or hearing protection earmuffs.

Some persons, such as firefighters or airport or military personnel, have a need to use a PPD when working. It is desirable to be able to communicate electronically with the user in such a circumstance. The PPD can, however, inhibit or block sound communication.

It is known to provide, for earmuffs or a helmet, a speaker and microphone and a hard-wired connection to an intercom system.

### SUMMARY OF THE INVENTION

In one aspect the invention relates to apparatus comprising a personal protection device, a microphone and speaker on the device, a cell phone, and a cable for electrically connecting the microphone and the speaker with the cell phone. In another aspect the invention relates to apparatus comprising a personal protection device, a microphone and speaker on the device, and a cable for electrically connecting the microphone and the speaker with the cell phone. In still another aspect, the invention relates to a cable for electrically connecting the microphone and the speaker that are on a personal protection device, with a cell phone.

### BRIEF DESCRIPTION OF THE DRAWINGS

Further features of the invention will be apparent to one of ordinary skill in the art to which the invention pertains, from a reading of the following description in conjunction with the attached drawings, in which:

FIG. 1 is a pictorial illustration of a first embodiment of the invention including a mask; and

FIG. 2 is a pictorial illustration of a second embodiment of the invention including a hearing protector.

### DETAILED DESCRIPTION OF AN EMBODIMENT

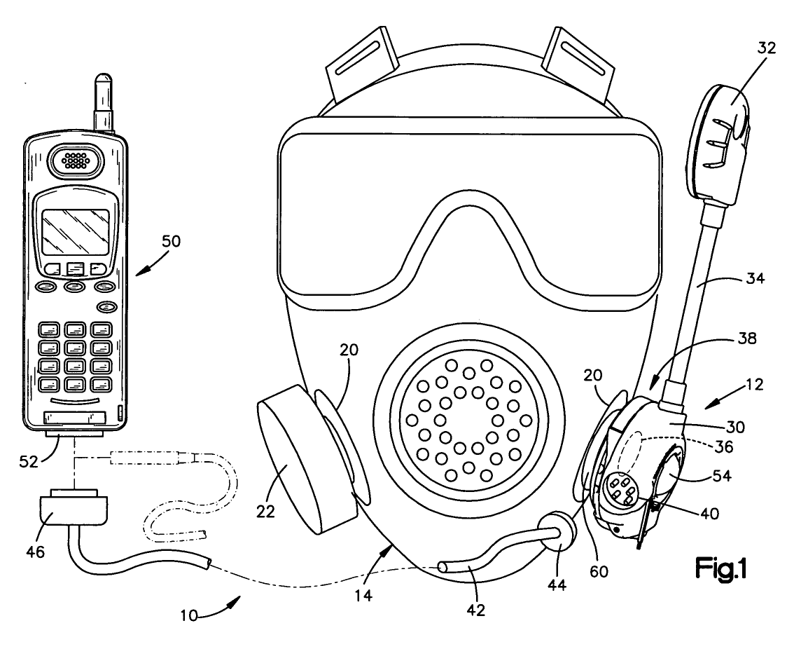

This invention relates to a personal protection device (“PPD”), such as a mask, a helmet, or hearing protection earmuffs, and to a method and apparatus for enabling communication via cell phone when a user is wearing a PPD. As representative of the invention, FIG. 1 illustrates an apparatus 10 that is a first embodiment of the invention.

The apparatus includes a mask shown schematically at 14. The mask 14 could be any type of personal protection device that at least partially covers the user's mouth so as to make it not feasible to communicate in a normal manner via cell phone. The invention is applicable to masks of varying types and constructions. The particular mask 14 that is illustrated is made from rubber or another material suitable to prevent the person wearing it from inhaling air that is not filtered.

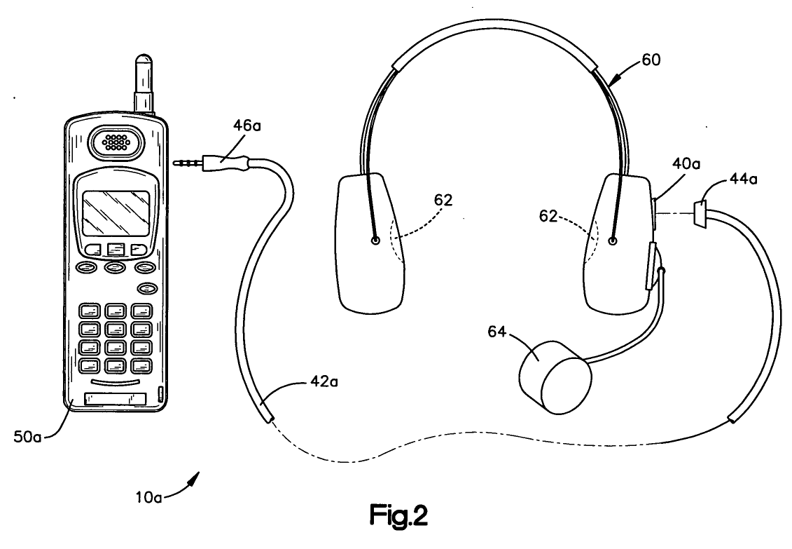

The invention is applicable to other types of personal protection devices, including but not limited to a helmet or an ear protection device (earmuff). As but one example, FIG. 2 (described below) shows the invention used with earmuffs.

The mask 14 (FIG. 1) has two filter ports 20, each of which can support a filter that filters air for a person to breathe. Only one filter, supported on one filter port, is required to allow the person wearing the mask to breathe filtered air. The other filter port can be used for other functions or can be sealed. As shown in FIG. 1, the mask 14 supports a filter 22 on one of the filter ports 20.

The second filter port 20 (i.e., the one not being used for a filter 22) may be used for communication. When the second filter port 20 is used for communication, a voice emitter (not shown) is located in the filter port. A communication device may be supported on the filter port 20 of the mask 14, to allow the user of the mask to transmit sound electronically away from the mask, and to hear other people who are transmitting sounds to the user.

The particular communication device 12 that is shown in FIG. 1 is a microphone and speaker combination. The device 12 includes a main body 30, and an ear speaker 32 (FIG. 1) on a boom 34. The main body 30 contains a microphone (shown schematically at 36) located adjacent the voice emitter. The boom 34 is a long, thin, member one end of which is attached to the main body 30 and the other end of which supports the speaker 32. Other types of communication devices are suitable for use with the invention. For example, the microphone can be a bone conduction microphone, or an ear microphone, and the speaker can be an ear speaker.

The apparatus 10 includes an attachment mechanism 38 for attaching the communication device 12 to the mask. The attachment mechanism 38 could be some kind of mounting bracket, for example, as shown in commonly owned co-pending U.S. application Ser. No. 11/044,129, filed Jan. 27, 2005, the entire disclosure of which is hereby incorporated by reference; or could be of another type, many of which are known in the art. The particular attachment mechanism 38 that is shown may depend on the particular microphone 36 and speaker 22 to be attached to the mask 14.

On the attachment mechanism 38 for the communication device 12, or on the communication device itself, is an electrical connector 40 that forms part of the apparatus 10. The connector 40 is electrically connected with the microphone 36 and the speaker 32, to enable transmission of an outgoing voice signal from the microphone to a location off the mask 14, and to enable transmission of an incoming voice signal from a location outside the mask to the ear speaker.

The apparatus 10 also includes a cable 42. The cable 42 is suitable for carrying a cell phone conversation/signal, in either full duplex mode or half duplex mode.

At its first end the cable 42 includes a connector 44 that is engageable with the mask-mounted connector 40. At its second end, the cable 42 has a connector 46 for electrical connection with a cell phone 50, to enable half duplex or full duplex transmission of signals between the cable and the cell phone.

The cell phone 50 may be considered to be part of the apparatus 10, or may be considered to be separate from but usable with the apparatus 10. The cell phone 50 has a port or connector 52 for electrical connection with an external speaker and microphone.

The apparatus 10 may optionally include a push to talk switch or button, as shown at 54, if a half-duplex communication setup is used. The PTT button 54 may be located on the mask 14 or on the mask communication device 12.

In operation of the apparatus 10, the connector 44 on the first end of the cable 42 is plugged into the mask-mounted connector 40. The connector 46 on the other end of the cable 42 is plugged into the connector 52 on the cell phone 50.

If the apparatus 10 is configured for operation in full duplex mode, no PTT switch is used. When the user speaks, the user's voice is picked up by the microphone 36 and an outgoing voice signal is sent over the cable 42 to the cell phone 50. The user's voice can thus be transmitted over the cell phone 50.

When an incoming voice signal is received by the cell phone 50, that signal is sent through the cable 42 to the mask 14, and specifically, to the communication device 12. The signal is sent to the speaker portion 32 of the communication device 12, and as a result the user can hear the incoming voice signal from the cell phone 50.

Thus, the user of the mask 14 is able to communicate over the cell phone 50, in a relatively normal manner, even though the user is wearing a mask.

If the apparatus 10 is configured for operation in half duplex mode, the PTT switch 54 is pressed when the user speaks, so that the user's voice is sent over the cable 42 to the cell phone 50. The user's voice can thus be transmitted over the cell phone 50. When an incoming voice signal is received by the cell phone 50, that signal is sent through the cable 42 to the ear speaker 32 whenever the PTT switch 54 is not activated.

FIG. 2 illustrates an apparatus 10a that is a second embodiment of the invention. The apparatus 10 exemplifies use of the invention with a personal protection device other than a mask, in this case, a hearing protector (earmuff) 60.

The hearing protector 60 includes a microphone 64 and two speakers 62. The apparatus 10a includes a cable 42a that has a connector 44a that plugs into a connector 40a on the hearing protector 60. The cable 42a has at its opposite end a connector 46a that plugs into a connector on a cell phone 50a. In this manner, the microphone 64 and the speakers 62 act as external microphone and speakers for the cell phone 50a.

From the above description of the invention, those skilled in the art will perceive improvements, changes, and modifications in the invention. Such improvements, changes, and modifications within the skill of the art are intended to be included within the scope of the appended claims.

Having described the invention, we claim:

1. Apparatus comprising:
a personal protection device;
a microphone and speaker on the device a cell phone; and
a cable for electrically connecting the microphone and the speaker with the cell phone.

2. Apparatus as set forth in claim 1 wherein the cell phone has a port for external connection of microphone and speaker, and the cable includes a first connector for engagement with the port.

3. Apparatus as set forth in claim 2 wherein the cable includes a second connector for engagement with the microphone and speaker on the device.

4. Apparatus as set forth in claim 3 including a mounting bracket for holding the microphone on the device, the mounting bracket having a second port for receiving the second connector.

5. Apparatus as set forth in claim 1 wherein the microphone is a bone conduction microphone or a boom microphone or an ear microphone.

6. Apparatus as set forth in claim 1 wherein the apparatus is configured electrically for operation in full duplex mode.

7. Apparatus as set forth in claim 1 wherein the apparatus is configured electrically for operation in half duplex mode and includes a push to talk switch.

8. A cable comprising a first connector at one end for electrical connection with a microphone and speaker of a communication device adapted for mounting on a personal protection device, and a second connector for electrical connection with a cell phone, to enable the microphone and speaker serve as an external microphone and speaker of the cell phone.

9. Apparatus comprising:
a personal protection device having a microphone and speaker; and
means for electrically connecting the microphone and speaker with a cell phone.

10. Apparatus as set forth in claim 9 wherein the means for electrically connecting comprises a cable.

11. Apparatus as set forth in claim 10 wherein the cable includes a first connector for connecting the cable with the cell phone and a second connector for connecting the cable with the microphone and speaker.

12. Apparatus comprising:
a personal protection device;
a microphone and speaker on the device; and
a cable for electrically connecting the microphone and the speaker with a cell phone.

13. Apparatus as set forth in claim 12 for use with a cell phone having a port for external connection of microphone and speaker, wherein the cable includes a first connector for engagement with the port and a second connector for engagement with the microphone and speaker on the device.

14. Apparatus as set forth in claim 13 including a mounting bracket for holding the microphone on the device, the mounting bracket having a second port for receiving the second connector.

15. Apparatus as set forth in claim 12 wherein the microphone is a bone conduction microphone or a boom microphone or an ear microphone.

16. Apparatus as set forth in claim 12 wherein the apparatus is configured electrically for operation in full duplex mode.

17. Apparatus as set forth in claim 12 wherein the apparatus is configured electrically for operation in half duplex mode and includes a push to talk switch.
